(19) United States
(12) Patent Application Publication
(10) Pub. No.: US 2015/0014094 A1
(43) Pub. Date: Jan. 15, 2015

(54) LADDER ACCESSORY HOLDER EXTENSION

(71) Applicant: John Reginald Brooks, Marshville, NC (US)

(72) Inventor: John Reginald Brooks, Marshville, NC (US)

(21) Appl. No.: 13/941,788

(22) Filed: Jul. 15, 2013

(51) Int. Cl. E04G 5/00; E06C 7/14

(52) U.S. Cl. CPC E04G 5/003; E06C 7/14
USPC 182/129

(57) ABSTRACT

The invention is an accessory holder that may be attached to the leg of a support structure such as a ladder or scaffold. The accessory holder may have an attachment member for attaching the accessory holder the leg of a support structure. The accessory holder may have an extension member extending above the uppermost support member of the support structure when the support structure is deployed. The accessory holder may have a container attached to an end of the extension member. The accessory holder may have a substantially planar bottom and may have sidewalls for supporting and containing implements.

### TECHNICAL FIELD AND BACKGROUND OF THE INVENTION

The present invention relates to the field of scaffolding and ladders and particularly to field of accessories for scaffolding and ladders. The invention includes an attachable accessory container, such as a tray, tub, box or bucket, which extends vertically beyond the top of various types of structures used to gain height above a supporting surface, particularly where the user requires access to implements while on the structure. Descriptions and definitions of these structures, such as ladders and scaffolds, are found at http://www.ladders.net/type, and include step, extension, platform, telescoping and folding ladders, and various types of scaffolds.

For many years, humans have utilized ladders in order to extend a person's reach. Ladders have been employed in order to climb from one-surface to a higher location.

Ladders have broad applicability and are often utilized in order to afford access to areas otherwise not accessible.

Ladders have many uses and, as is often the case, a ladder is utilized not simply to observe an area but to perform an operation in or on a particular area. In such uses, it is quite common that the person using the ladder will require the use of tools or other materials and implements while using the ladder. An electrician may use wires and wire cutters atop a ladder. A plumber may use a pipe wrench atop a ladder. Decorators and painters may use paint brushes and brick masons may use trowels and mortar while atop a ladder.

Ladders may include some accessories that attempt to aid those who use ladders. For example, a folding step ladder may include a hook attached to a step of the ladder usable for hanging a paint bucket. Similarly, a step ladder may include a folding platform attached to a ladder for holding implements.

In most situations, however, such accessory holders are positioned at or below the level of the uppermost steps of the ladders. As a result, users must reach downward, sometimes very far downward, to grasp implements positioned on the accessory holder. Reaching down in such a manner can be inefficient as well as both difficult and dangerous. If a user of a ladder has to reach far down to obtain his tools, time may be wasted in reaching far down. Similarly, the user of the ladder expends energy and must bend and lift in order to reach implements placed on accessary holders of the prior art. Worse still, the user of a ladder may lose his balance when so reaching down and may risk falling from the ladder. Thus, there is a need in the art for an accessory holder that does not require the user of a ladder to reach far to place and access tools and other implements desirable for use while atop a ladder.

Additionally, ladders are lengthy and space consuming. Storage and transportation space for ladders may be of concern to some users. As such, ladder height may be limited not by the areas to be accessed but by the capacity for storage and transport. Ladders necessary to reach or perform a particular function may not be tall enough in certain circumstances. Further it is common for the top step or possibly the top two or three steps of a ladder to be unsafe for use. These steps or rungs are often labeled as such. Nevertheless, for many reasons, users do utilize and stand upon upper level steps even though they may be specifically labeled as not for use as a step. Thus, the above noted problems are exacerbated when users climb above the top steps and then attempt to reach even further down for tools and implements. Thus, there is a further need for an accessory holder that improves safety and reach above the upper steps of a ladder. There is also a need for a ladder accessory holder that may be utilized at elevated heights where storage or transportation space for the ladder may be limited.

Further, there is a need in the art for a ladder accessory holder that is adjustable in height by a particular user and for a particular application.

### SUMMARY OF THE INVENTION

It is therefore an object of the present invention to provide a ladder accessory holder that reduces the distance required to reach accessories while a user is utilizing a ladder.

It is a further object of the invention to provide a ladder accessory holder that improves safety and reach above the upper steps of a ladder.

It is a further object of the invention to provide a ladder accessory holder that may be utilized at elevated heights even where storage or transportation space for the longer ladder may be limited.

It is a further object of the invention to provide a ladder accessory holder that is adjustable in vertical height by a particular user and for a particular application.

These and other objects and advantages of the invention are achieved by providing a ladder accessory holder that may be attached to the leg of a ladder, scaffolding, or similar support structure. Such a support structure typically has at least two legs and at least one support member used for gaining height above a supporting surface. The accessory holder may include a container, an elongate extension member having an end attached to the container, and an attachment member carried by the extension member on an opposite end of the extension member from the container. The attachment member may be adapted for attaching the extension member to one of the legs at a position on the leg so that the container is positioned at a height above the support.

According to another embodiment of the invention, the container may include a substantially planar bottom. The container may be angled in relation to the extension member so that the substantially planar bottom is substantially parallel the supporting surface. The angled relationship may include a lockable swivel so that the angle can be adjusted as desired. Such a swivel may include an arrangement wherein a bolt extends through the extension member and may also extend to or through the container forming an axis about which the container swivels. The locking mechanism may include a threaded nut which may mesh with a threaded portion of the bolt.

According to another embodiment of the invention, the container may be detachable and containers of different sizes and shapes may be substituted as desired.

According to another embodiment of the invention, a length of the extension member is such that a person standing on the support member can access, in a standing position, the container.

According to another embodiment of the invention, the structure is selected form the group consisting of a step ladder, an extension ladder, a step stool, and a scaffold.

According to another embodiment of the invention, the attachment member may comprise a rectangular box with two parallel open sides and one closable hinged side, the leg of the structure passing through the parallel open sides of the box and the hinged side closing and securing the box around the leg. The hinged side may rotate about a hinge and latches to a side of the box opposite the hinge via a latch. Further, the latch may be a hasp.

According to another embodiment of the invention an inner perimeter of the open sides of the box may be slightly larger than a lateral cross-section of the leg of the structure so that the box fits tightly around the leg when the hinged side is closed.

According to another embodiment of the invention the extension member extends parallel to the leg to which the attachment member is attached.

According to another embodiment of the invention, the container may have perimeter sidewalls, the elongate extension member may include an end which is removably attached to the container; and the attachment member may be attached to one and only one of the legs at a position on the leg so that the container is positioned at a height above the support.

According to another embodiment of the invention, the container may include a lock that extends around the leg of the structure and secures the accessory holder to the structure.

According to another embodiment of the invention, the attachment member, the extension member, and the container may be made of a material which does not conduct electricity.

According to another embodiment of the invention, the container may have cavities through which implements are partially placed and secured, such as an opening through which the handle of a hammer passes but the head of the hammer rests on the tray bottom.

According to one embodiment of the invention, the extension member may include a length that is adjustable by a user. The length of the extension member may be sized so that a person standing on an upper rung can easily and safely access implements placed in the accessory tray.

According to another embodiment of the invention, the attachment member may be a clamp such as a C-clamp.

According to another embodiment of the invention the extension member may extend in a direction that is reverse tangential to leg to which the attachment member is attached. As used herein, reverse tangential means that the extension member extends away from the leg to which the attachment member is attached. For embodiments of support structures including two sets of parallel legs, this direction will be the direction generally parallel to the pair of legs to which the attachment member is not attached.

According to another embodiment of the invention, the attachment member, the extension member, and the container may be made of metal. The metal may be steel, aluminum, or magnesium.

According to another embodiment of the invention, the attachment member, the extension member, and the container may be made of fiber-glass.

According to another embodiment of the invention, the attachment member, the extension member, and the container may be made of wood or of a wood composite.

### BRIEF DESCRIPTION OF THE DRAWINGS

The present invention is best understood when the following detailed description of the invention is read with reference to the accompanying drawings, in which:

FIG. 1 is a perspective view of the accessory holder attached to a support structure;

FIG. 2 is a right side view of the accessory holder attached to a support structure;

FIG. 3 is a left side view of the accessory holder attached to a support structure;

FIG. 4 is a rear side view of the accessory holder attached to a support structure;

FIG. 5 is a front side view of the accessory holder attached to a support structure;

FIG. 6 is a perspective view of the accessory holder attached to a support structure with the attachment member in the closed position;

FIG. 7 is a perspective view of the accessory holder attached to a support structure with the attachment member in the open position;

FIG. 8 is a perspective view of the accessory holder that is detached from a support structure;

FIG. 9 is a perspective view of the accessory holder;

FIG. 10 is perspective view of the accessory holder with the container detached from the extension member; and

FIG. 11 is a perspective view of the accessory holder.

### DESCRIPTION OF THE PREFERRED EMBODIMENT AND BEST MODE

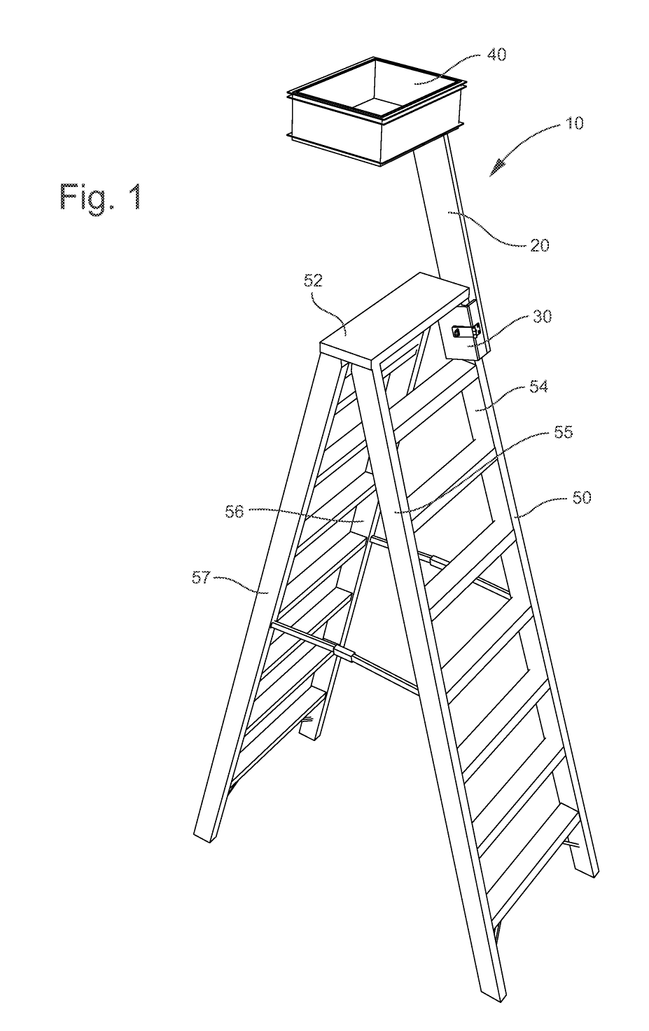

Referring now specifically to the drawings, a ladder accessory holder extension 10 is shown generally at reference numeral 10. Referring to FIG. 1, the accessory holder 10 is designed to attach to a support structure 50. The accessory holder 10 may attach to any leg 54, 55, 56, or 57 of the support structure but is shown as attached to leg 54. Similarly, the accessory holder 10 may attach to one leg 54 of a support structure 50 having only two legs instead of four legs.

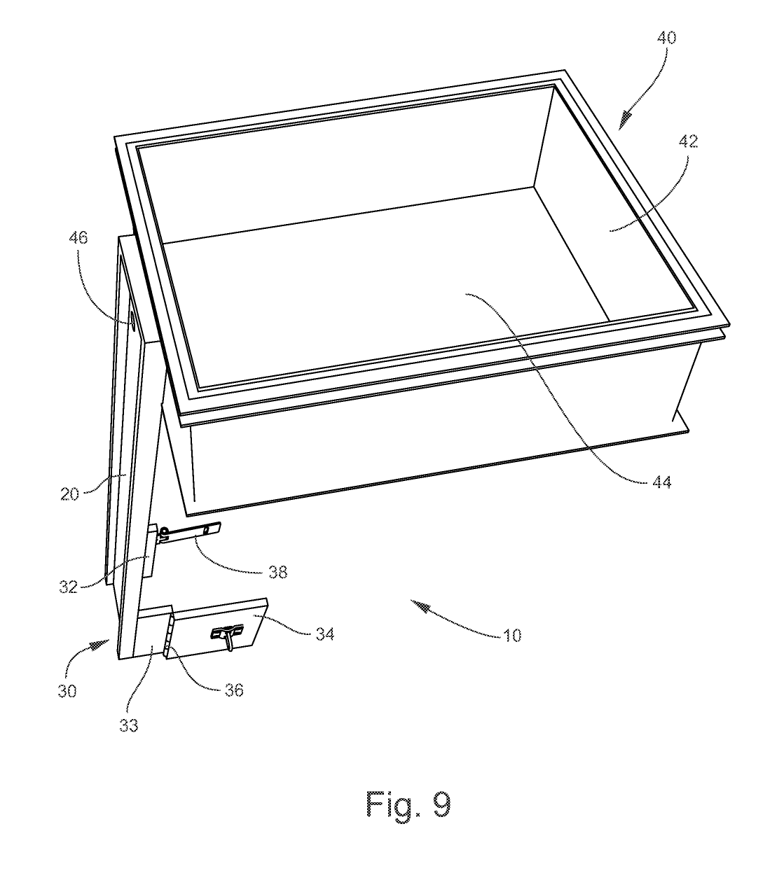

The accessory holder 10 has an attachment member 30, an extension member 20, and a container 40. As shown in FIG. 9, the container 40 has sidewalls 42 and a substantially planar bottom 44. The container 40 may be made of metal, wood, plastic, fiberglass, resin, or other composite material. The container 40 may be made of a material that is not a conductor of electricity. The container 40 may be made of a material that is a different material from the support structure 50. The sidewalls 42 may be made of a different material from the bottom 44.

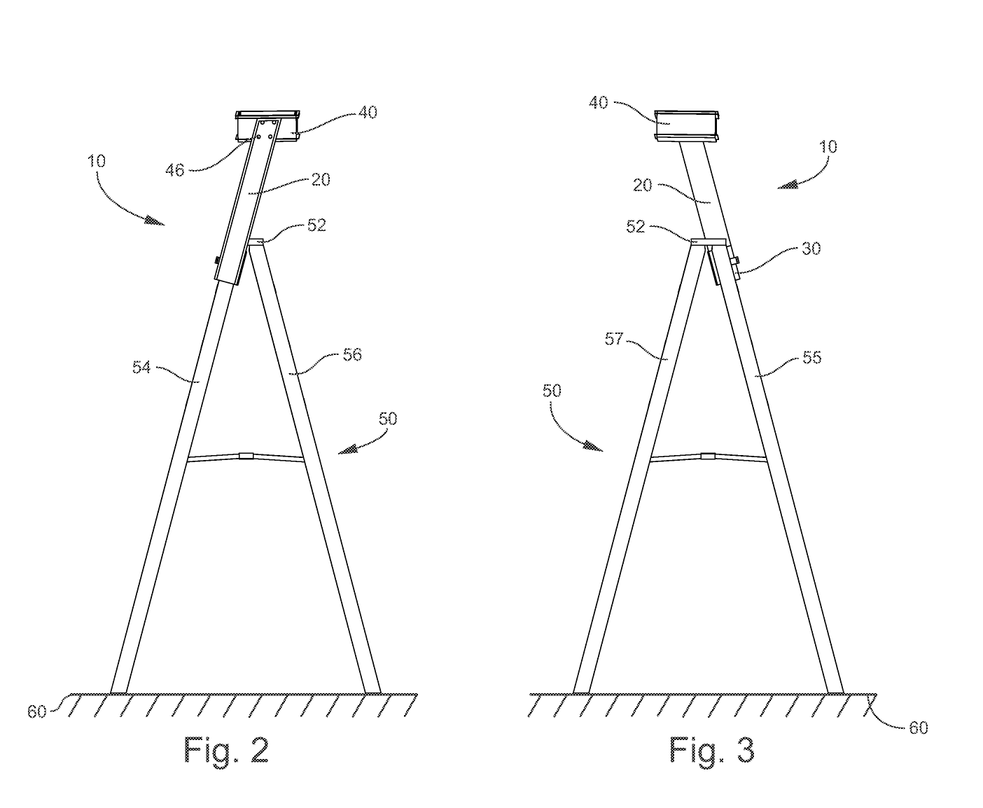

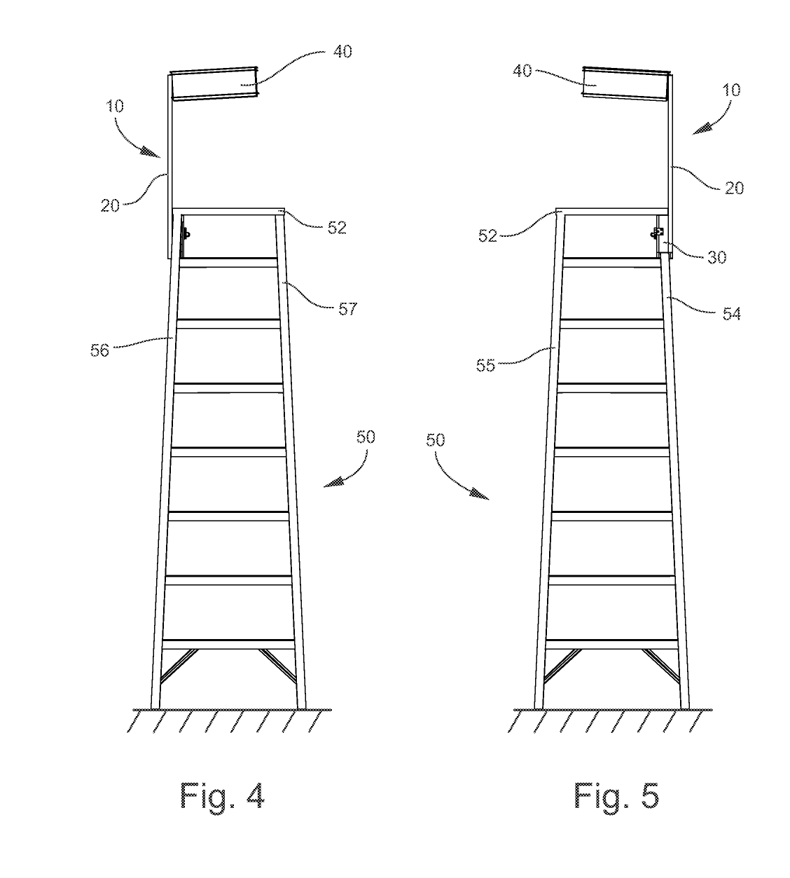

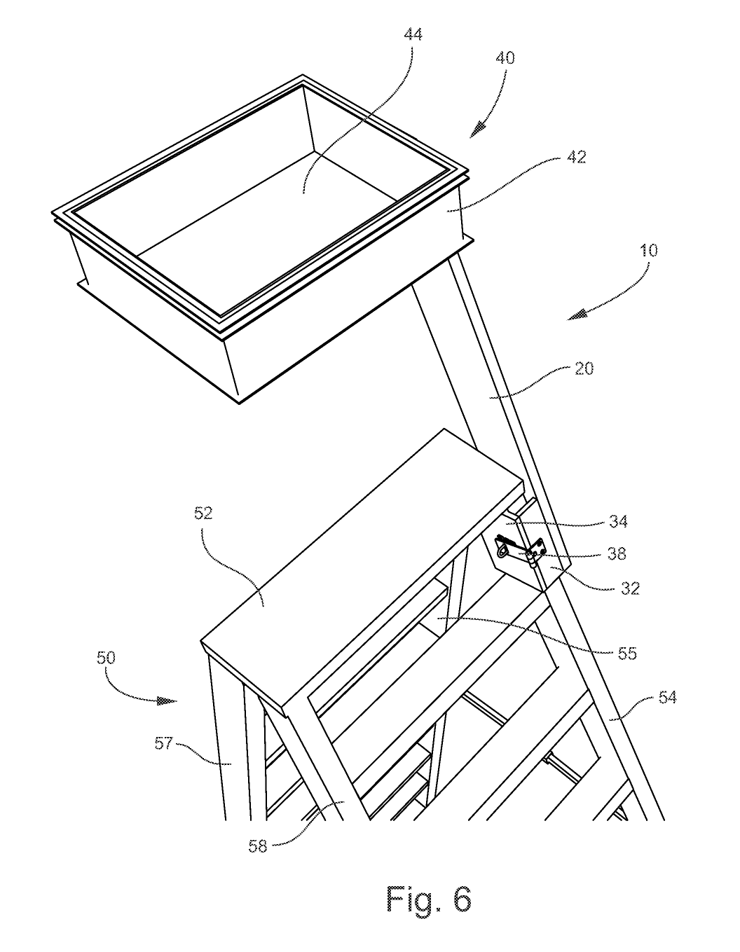

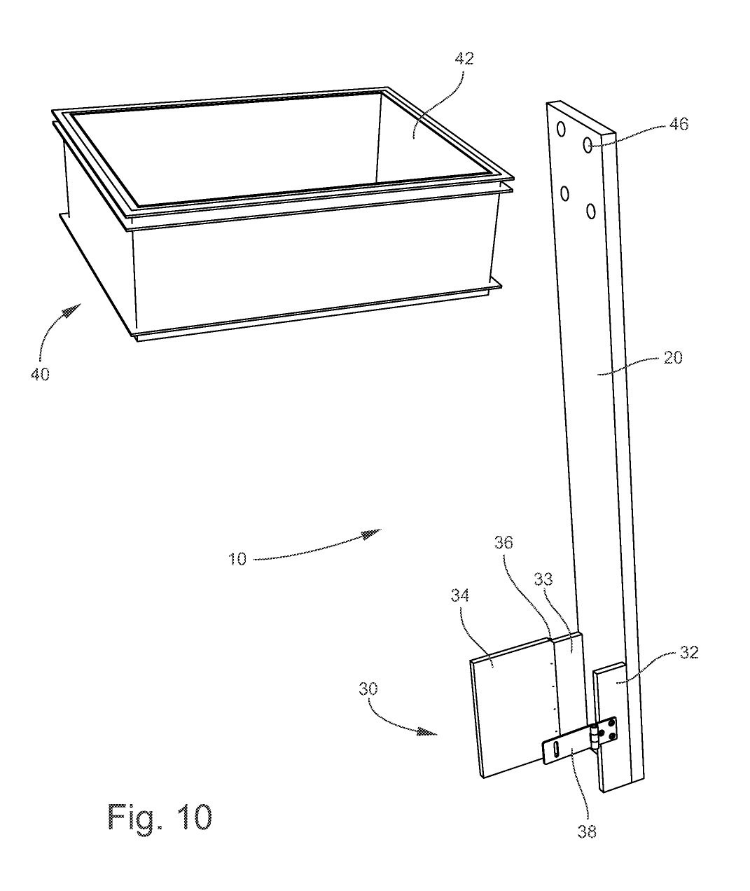

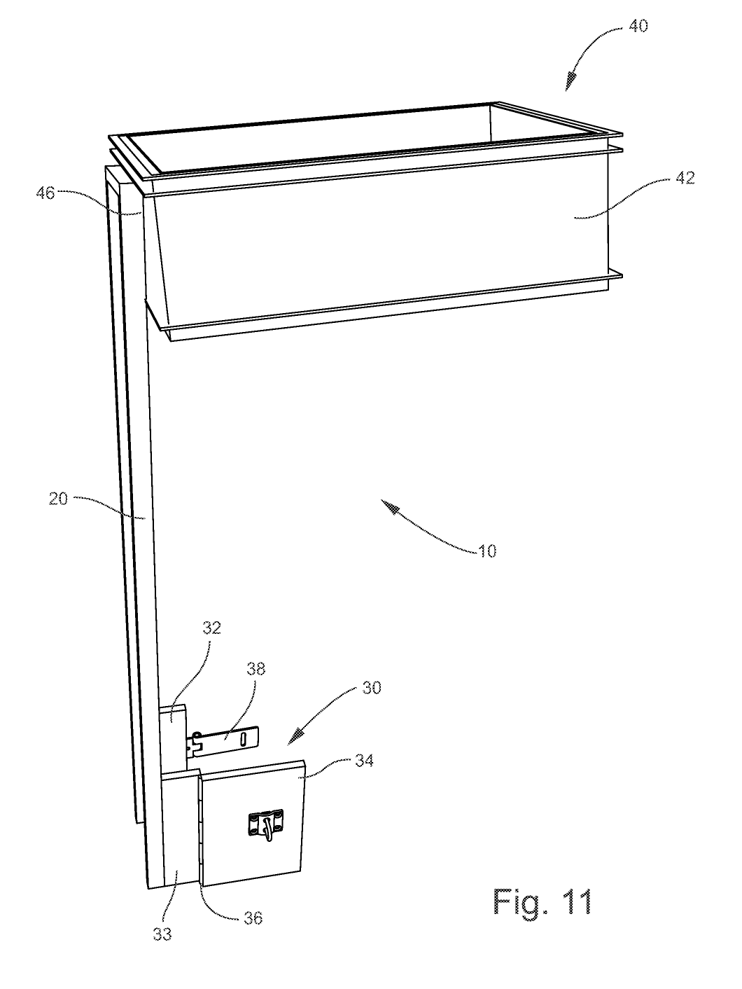

As shown in FIG. 9, FIG. 10, and FIG. 11, the container 40 is attached to the extension member 20 at attachment location 46. As shown in FIG. 10, the container 40 may be removably attached to the extension member 20 at attachment location 46. The removable attachment of the container 40 to the extension member 20 at attachment location 46 may utilize a threaded bolt connection. The attachment location 46 may include one or more attachment points though the embodiment as shown utilizes an attachment location 46 with four attachment points. As shown in FIG. 2, FIG. 3, FIG. 4, and FIG. 5, when the accessory holder 10 is attached to a leg 54 of a support structure 50, the container 40 will positioned at a distance above a supporting surface 60 and also above the uppermost support member 52 of the support structure 50.

As shown in FIG. 2, FIG. 3, FIG. 4, and FIG. 5, the distance of the container 40 above level supporting surface 60 and above the upper most support member 52 of the support structure 50 as just described is achieved in part by function of the extension member 20. The extension member 20 is attached to the container 40 at attachment location 46. The extension member 20 is attached to the attachment member 30. The extension member 20 extends above the uppermost support member 52 of the support structure 50. The extension member 20 may be made of metal, wood, plastic, fiberglass, resin, or other composite material. The extension member 20 may be made of a material that is not a conductor of electricity. The extension member 20 may be made of a material that is a different material from the support structure 50.

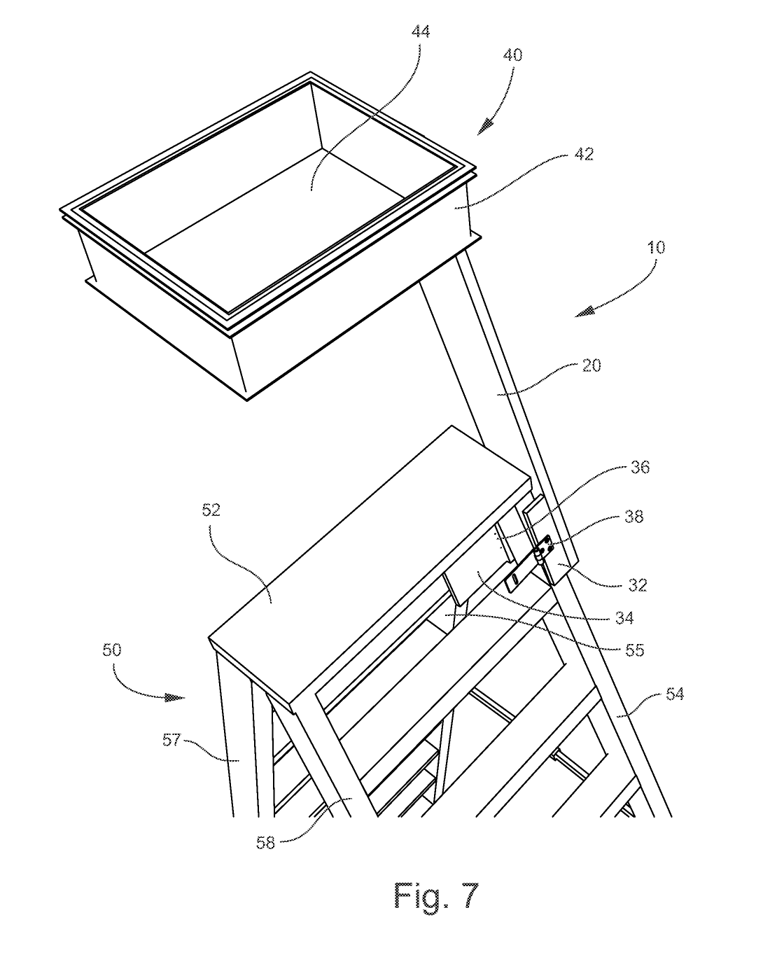

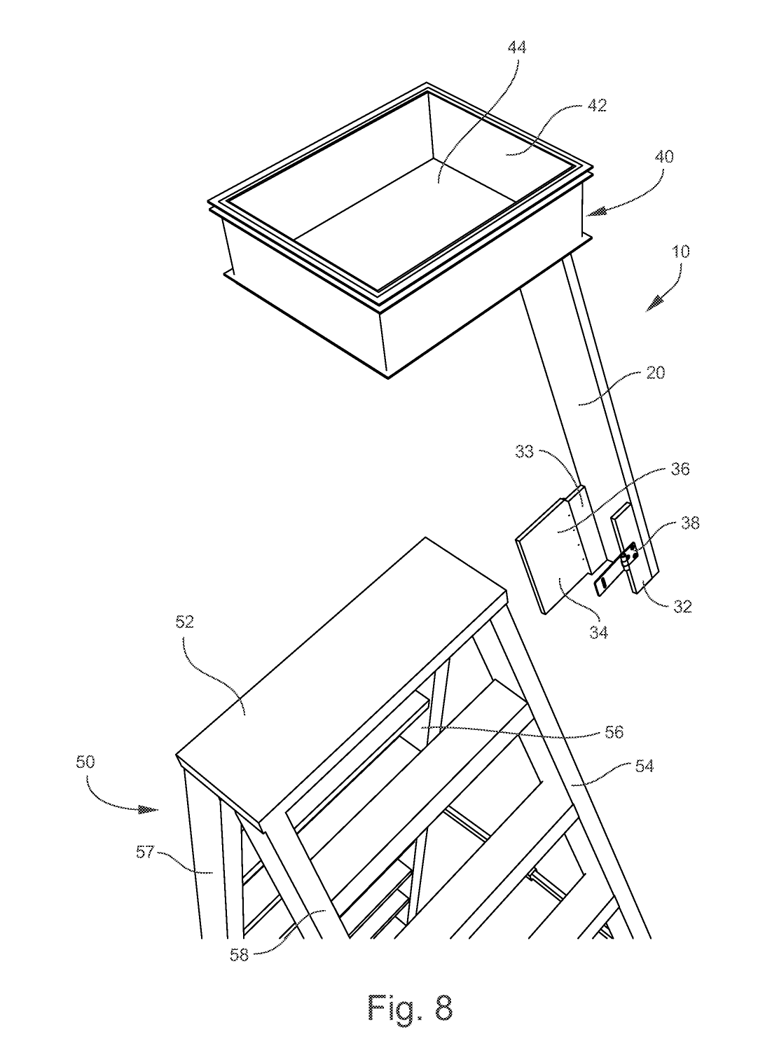

The extension member 20 may be rectangular, as shown in FIGS. 1, 6, 7, 8, and 10, or cylindrical (not shown). Referring to FIG. 1, the attachment member 30 is fixed to the extension member 20. The attachment member 30 is removably attachable to the support structure 50. The attachment member 30 may attach to any leg 54, 55, 56, or 57 of the support structure 50 and is shown as attached to leg 54. Referring especially to FIGS. 6-41, attachment member 30 has two parallel sides 32, 33 and a closable hinge side 34. The attachment member 30 also has two parallel open sides through which the leg 54 of the ladder 50 passes when the attachment member 30 is attached to the ladder 50. The closable hinge side 34 is attached to parallel side 33 via a hinge 36. The closable hinge 34 is secured to side 32 via a latch 38. As shown, the latch 38 is a hasp type latch. However, the invention contemplates use of other type latches and means of securing the closeable hinge 34 to side 32. The closable hinge side 34 rotates about the hinge 36 from an open position as shown in FIGS. 7-11 to a closed or locked position as shown in FIG. 1 and FIG. 6. When the attachment member 30 is attached to the support structure 50 in the locked position, the ladder accessory holder extension 10 is secured to the ladder 50 and ready for use. The attachment member 30 may be made of metal, wood, plastic, fiberglass, resin, or other composite material.

A ladder accessory holder extension 10 according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1.-9. (canceled)

10. An accessory holder for use with a structure having a plurality of legs for gaining height above a supporting surface comprising:
a. a container having perimeter sidewalls and a substantially planar bottom;
b. an elongate extension member having an end which is removably attached via a lockable swivel connection to the container;
c. an attachment member carried by the extension member on an opposite end of the extension member from the container and adapted for attaching the extension member to one and only one of the legs at a position on the leg so that the container is positioned at a height above the support;
d. a lock, carried by the attachment member for preventing theft of the accessory holder, that extends around the leg of the structure and secures the accessory holder to the structure, wherein the lock comprises a rectangular box with two parallel open sides and one, and only one, closeable hinged side, the leg of the structure passing through the parallel open sides of the box and the hinged side closing and securing the box around the leg, and wherein the hinged side rotates about the hinge and latches to a side of the box opposite the hinge via a lockable hasp latch;
e. wherein the container is angled in relation to the extension member so that the substantially planar bottom is substantially parallel to the supporting surface; and
f. wherein the extension member extends parallel to the leg to which the attachment member is attached.

11. (canceled)

12. (canceled)

13. The accessory holder of claim 10 wherein a length of the extension member is such that a person standing on the support member can access, in a standing position, the container.

14. (canceled)

15. (canceled)

16. (canceled)

17. The accessory holder of claim 14 wherein an inner perimeter of the open sides of the box is slightly larger than a lateral cross-section of the leg of the structure so that the box fits tightly around the leg when the hinged side is close.

18. (canceled)

19. The accessory holder of claim 10 wherein the attachment member, the extension member, and the container are made of a material which does not conduct electricity.

20. The accessory holder of claim 10 wherein the structure is selected form the group consisting of a step ladder, an extension ladder, a step stool, and a scaffold.
